(19) United States
(12) Patent Application Publication
(10) Pub. No.: US 2014/0245586 A1
(43) Pub. Date: Sep. 4, 2014

(54) HOLSTER FOR DISPLAYING MEDAL SUSPENDED FROM RIBBON

(71) Applicant: Rohtek, LLC, Bothell, WA (US)

(72) Inventor: Oscar H. Rojas, Bothell, WA (US)

(73) Assignee: Rohtek, LLC, Bothell, WA (US)

(21) Appl. No.: 14/187,582

(22) Filed: Feb. 24, 2014

Related U.S. Application Data
(60) Provisional application No. 61/771,836, filed on Mar. 2, 2013.

(51) Int. Cl. F16M 13/02

(52) U.S. Cl. CPC F16M 13/02
USPC 29/428; 248/316.8; 248/304; 425/162

(57) ABSTRACT

At least devices and methods for displaying medals suspended from ribbons on vertical surfaces. In embodiments, a holster includes a backing plate that has a front face and a rear face. The rear face can be configured to be attached to the vertical surface, such as a wall or a frame. The holster further includes two shelves attached to the front face and configured to support the ribbon. The shelves can leave a vacant space between them for the medal to be suspended therethrough, when the ribbon is supported on the shelves. Accordingly, the medal can be displayed along with the decorative ribbon being held also in substantially full view.

### CROSS REFERENCE TO RELATED PATENT APPLICATIONS

This patent application claims priority from U.S. Provisional Patent Application Ser. No. 61/771,836, filed on Mar. 2, 2013, titled: “HOLSTER FOR MEDAL WITH RIBBON”, the disclosure of which is hereby incorporated by reference for all purposes.

### BACKGROUND

Medals are presented to people on occasion of merit. For the example of armed forces, the occasion can be one of conspicuous valor, but there are also many other contexts. Medals can be worn on one's person with justifiable pride.

A medal is oftentimes suspended from a ribbon that can be folded. The medal can be worn by attaching the ribbon to one's clothing. Beyond being used to merely suspend medals, ribbons themselves are often significant and decorative with appropriate colors, in a way that complements the awarded medal.

There is a challenge as to how one would display a medal when not wearing it, such as in an office. The problem can be faced by those retiring from service in the armed forces. If the problem is solved by merely supporting the medal as a coin, then the ribbon would not be displayed properly, or it might obscure the medal itself.

### BRIEF SUMMARY

The present description gives instances of at least devices and methods for displaying medals suspended from ribbons on vertical surfaces, the use of which may help overcome problems and limitations of the prior art.

In some embodiments, a holster includes a backing plate that has a front face and a rear face. The rear face can be configured to be attached to the vertical surface of interest. The holster further includes two shelves attached to the front face and configured to support the ribbon. The shelves may leave a vacant space between them for the medal to be suspended therethrough, when the ribbon is supported on the shelves.

An advantage over the prior art is that the medal can be displayed along with the decorative ribbon being held also in substantially full view.

These and other features and advantages of this description will become more readily apparent from the following Detailed Description, which proceeds with reference to the drawings, in which:

### BRIEF DESCRIPTION OF THE DRAWINGS

FIG. 1 is a perspective view of a holster made according to embodiments.

FIG. 2 is another perspective view of the holster of FIG. 1.

FIG. 3 is a front view of the holster of FIG. 1, and where geometric lines are further added to illustrate a preferred shelf inclination according to embodiments.

FIG. 4 is a side view of the holster of FIG. 1.

FIG. 5 is a rear view of the holster of FIG. 1.

FIG. 6 is a flowchart illustrating methods according to embodiments.

FIG. 7 is a diagram showing an example of how components can be used to implement the methods of FIG. 6 according to embodiments.

FIG. 8 is a perspective view of the holster of FIG. 1, after a specific embodiment of FIG. 7 has been implemented.

FIG. 9 is a front view of the holster of FIG. 5 supporting a medal as implemented in FIG. 8.

### DETAILED DESCRIPTION

As has been mentioned, the present description is about at least devices and methods for displaying medals suspended from ribbons. Embodiments are now described in more detail.

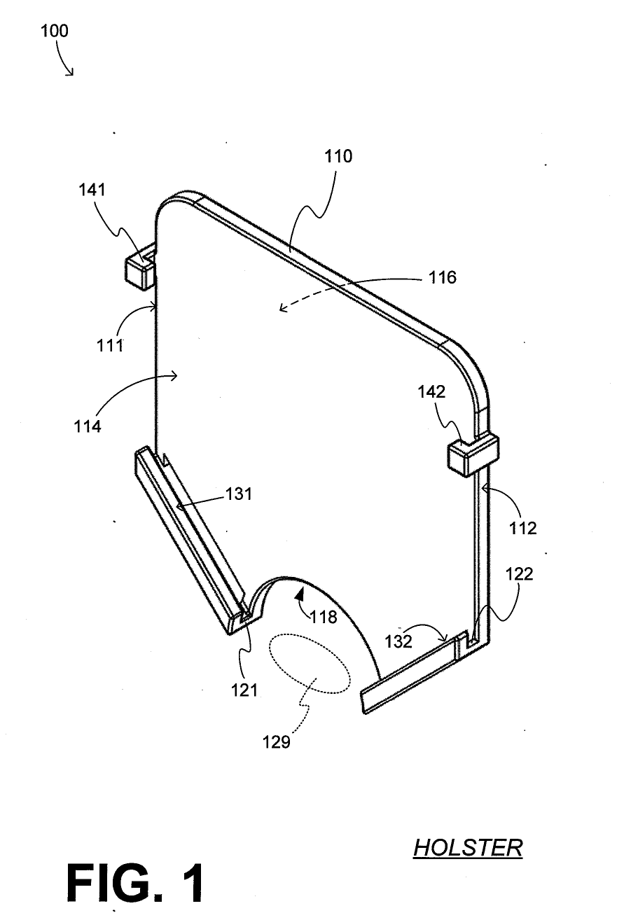

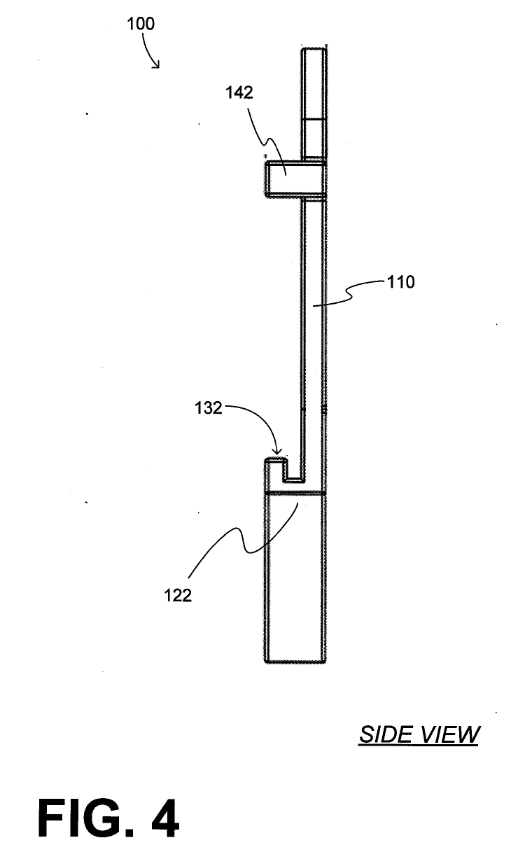

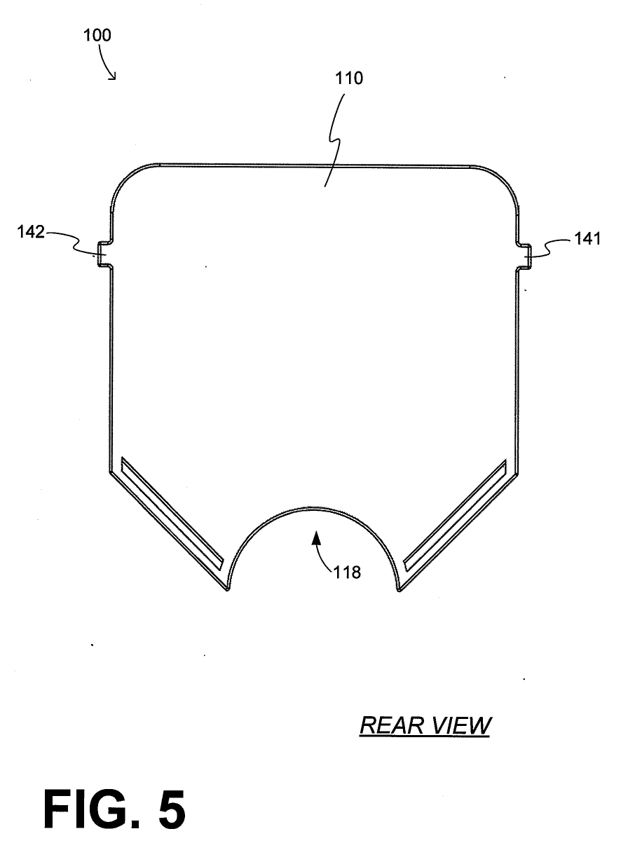

FIGS. 1-5 are various views of a holster 100, which is made according to embodiments. It will be appreciated from this description that holster 100 includes many refinements that improve the product, but are not absolutely necessary for practicing basic forms of the invention. For that reason, some of the general descriptions in this document do not necessarily apply to the exact refined embodiment of holster 100.

In general, a holster according to embodiments is configured to display a medal that is suspended from a ribbon. Displaying can be on a vertical surface, such as a wall, a certificate, a frame such as one showcasing a certificate and so on. The holster can be made from any suitable material, such as plastic by injection molding or 3D printing.

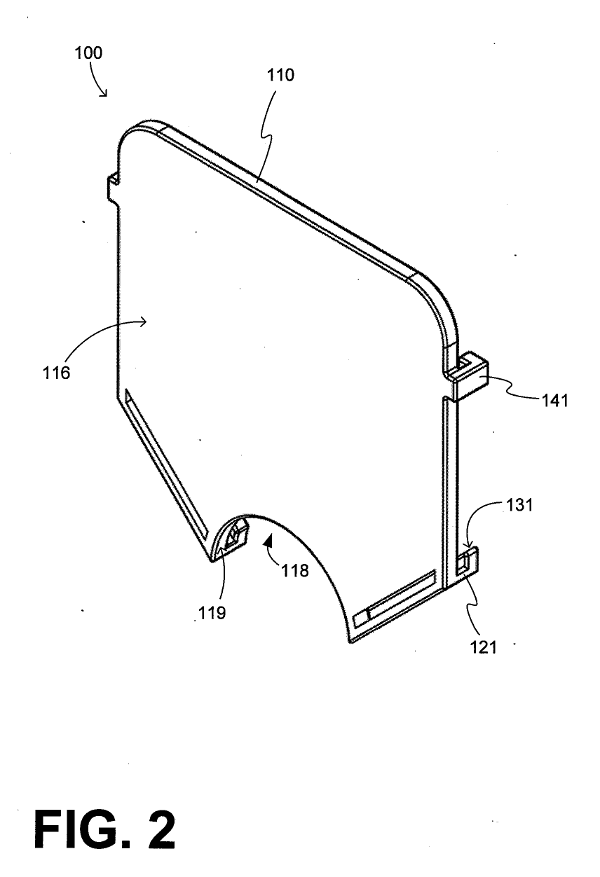

In general, a holster according to embodiments includes a backing plate that has a front face and a rear face. In the example of FIGS. 1-5, holster 100 includes a backing plate 110 that is substantially flat. Backing plate 110 has a front face 114 and a rear face 116, both of which are also flat. Front face 114 is indicated in FIG. 1, and rear face 116 is indicated most directly in FIG. 2.

The rear face, such as rear face 116, can be configured to be attached to a vertical surface, examples of which were given above. Attachment can be by any number of ways, as will be evident to a person skilled in the art. For example, the rear face can include a ready nail or pin for inserting in the vertical surface. Or it can include an opening, to receive the head of a nail that has been independently inserted in the vertical surface. Or, the rear face can be reasonably flat so that it can adhere well to double sided tape, the other side of which can be attached to the vertical surface.

In general, a holster according to embodiments further includes two shelves that can be attached to the front face of the backing plate. In the example of FIGS. 1-5, holster 100 includes two shelves 121, 122.

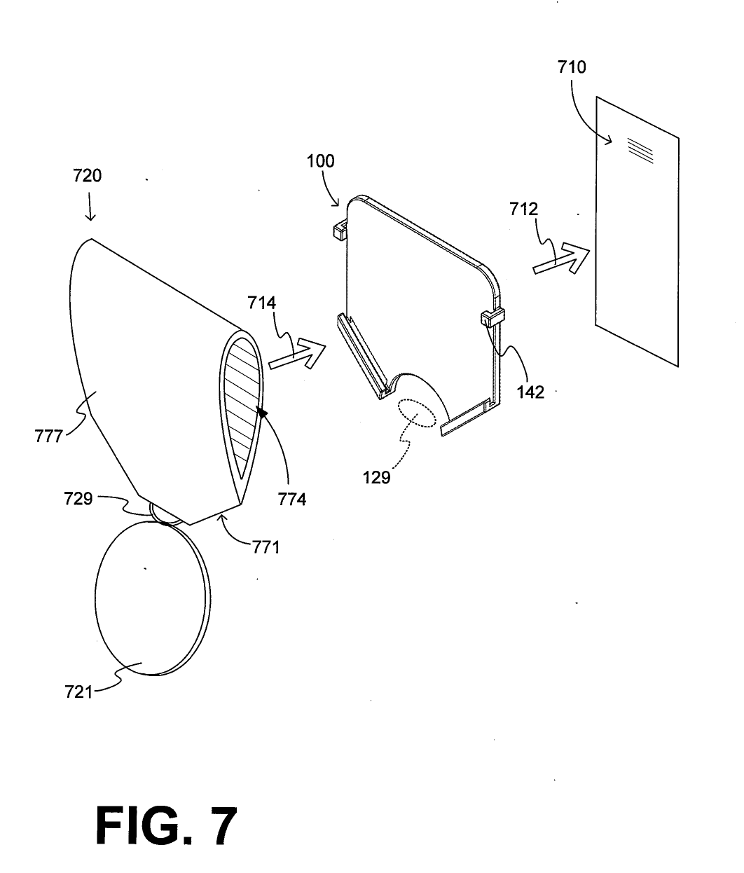

An aspect of the shelves is that they can be configured to support the ribbon, preferably from an underside of the ribbon, an example of which will be shown later in FIG. 7. One way to accomplish this is by the shelves' having a surface that can support the ribbon, such as from the underside. In the example of FIGS. 1-5, shelves 121, 122 include a surface that is perpendicular to a plane of backing plate 110.

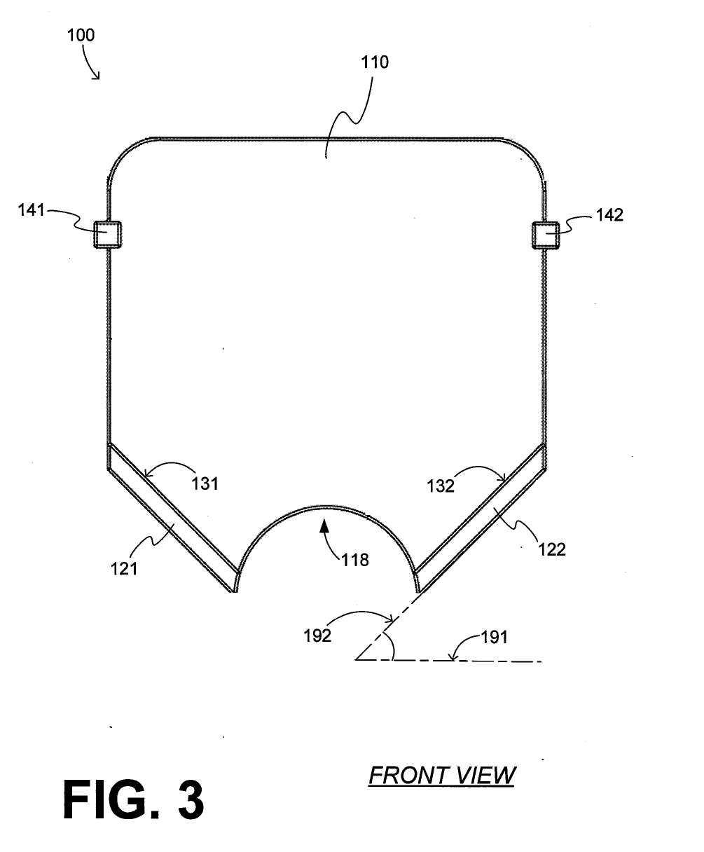

The shelves may be horizontal or inclined. If they are inclined, the shelves can be substantially inclined with respect to each other. In the embodiment of FIGS. 1-5, shelves 121, 122 are inclined at approximately 45° from the horizontal. The angle can be best seen in FIG. 3, where geometric lines 191, 192 have been further added to illustrate the inclination from the horizontal. Line 191 is horizontal. The angle subtended between lines 191, 192 is 45°. Accordingly, shelves 121, 122 are substantially perpendicular to each other.

In embodiments, the shelves are attached at some point of the backing plate. In some embodiments, the backing plate has a bottom side, and the shelves are aligned with the bottom side. In such embodiments, it is possible that no part of the holster extends below the shelves. That is also preferred, so as to minimize the weight and cost of the device, while also minimizing its interference with the appearance of the medal.

In embodiments such as the example of FIGS. 1-5, each of shelves 121, 122 is oblong and continuous. That is preferred for aesthetics, but not necessary. In fact, for structural purposes the shelves can be short, such as mere pegs. Those, however, may detract attention from the displayed medal in some instances.

In embodiments, the shelves can leave a vacant space between them. This way, the medal can be suspended through the vacant space when the ribbon is supported on the shelves. In the sample embodiment of FIGS. 1-5, shelves 121, 122 leave a vacant space 129 between them.

In embodiments, the backing plate has a bottom side, as described above. Moreover, the backing plate could have a cutout at the bottom side. The cutout can be located proximately to the vacant space. In the sample embodiment of FIGS. 1-5, a bottom side 119 of backing plate 110 is indicated in FIG. 2. Bottom side 119 has a cutout 118. The cutout can facilitate the supporting by making more room, in other words effectively extending vacant space 129 towards where backing plate 110 would otherwise be.

In embodiments, one or more of the shelves can include respective fences. When provided, these fences can be configured so that they prevent the ribbon from sliding off the shelves. Prevention can be by the fences being substantially vertical. In the sample embodiment of FIGS. 1-5, shelf 121 includes a fence 131, and shelf 122 includes a fence 132. The relationship is seen clearly in FIG. 2, where a small portion of shelf 121 is perpendicular to a plane of backing plate 110, and fence 131 is upright. In these embodiments, fences 131, 132 are further coextensive with shelves 121, 122, although that is not necessary.

In embodiments, a holster further includes one or more hooks that can be configured to engage the ribbon. The intent of engaging the ribbon is to help it be held up vertically. The one or more hooks can protrude from the backing plate. In some of these embodiments, the backing plate has two side edges, and one of the hooks protrudes from one of the side edges. In the embodiment of FIGS. 1-5, holster 100 further includes hooks 141, 142, which protrude from backing plate 110. In fact, backing plate 110 has two side edges 111, 112, and hooks 141, 142 protrude from side edges 111, 112 respectively.

The hook can have many different shapes. In embodiments, the ribbon includes a fold, and the hook is configured to be received in the fold. The hook can be blunt so as not to tear the fabric of the ribbon.

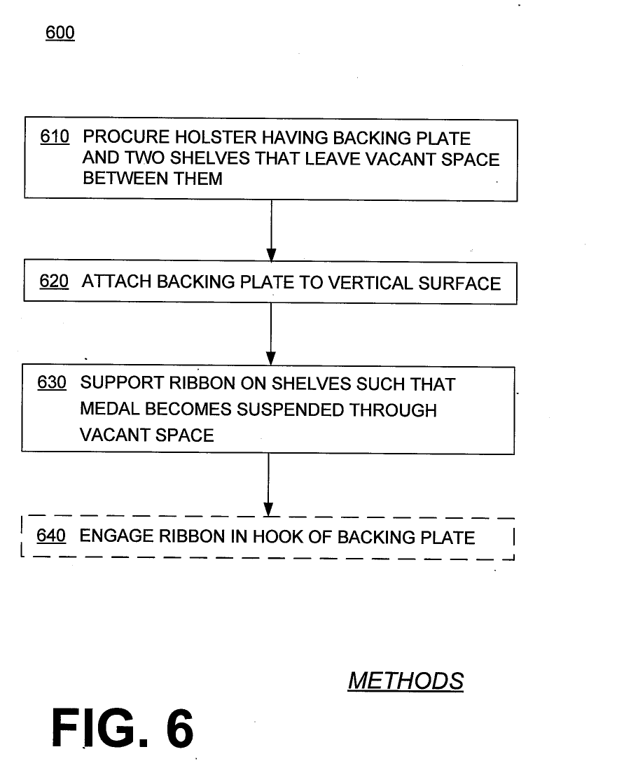

FIG. 6 shows a flowchart 600 for describing methods according to embodiments. The methods are for displaying on a vertical surface a medal that is suspended from a ribbon. The methods of flowchart 600 may also be practiced by embodiments described above. For example, FIG. 7 shows how components can be used to implement the operations of FIG. 6.

FIG. 7 shows a sample vertical surface 710, which can be as described above. In addition, FIG. 7 shows a medal 721 suspended from a ribbon 777. In this example, suspension is via a loop 729, although the suspension can be implemented differently. Medal 721, ribbon 777 and loop 729 can also be together called medal assembly 720. In the example of FIG. 7, ribbon 777 includes a fold 774.

Returning to FIG. 6, according to an operation 610, a holster is procured. The holster can have a backing plate, and two shelves that leave a vacant space between them. Procuring can be performed in any number of ways, such as by purchasing, or by printing in a 3D printer, and so on. Operation 610 can be contributed to by transmitting, or enabling to be downloaded one or more data files that can drive the nozzle of a 3D printer.

In the example of FIG. 7, the holster is the previously described holster 100. Of all its features, holster 100 is shown in FIG. 7 with further indicating vacant space 129 and hook 142.

According to another operation 620 of FIG. 6, the backing plate is attached to the vertical surface. In the example of FIG. 7, holster 100 is brought to surface 710 according to an arrow 712, and then it is attached to it.

According to another operation 630 of FIG. 6, the ribbon is supported on the shelves. Supporting is such that the medal becomes suspended through the vacant space. In the example of FIG. 7, ribbon 777 is brought to holster 100 according to an arrow 714, and then it is supported on its shelves. Loop 729 is thus placed in vacant space 129.

Shelves 121, 122 will receive underside 771, for supporting it. Underside 771 of ribbon 777 can be inclined. Shelves 121, 122 are inclined so that they match the incline of underside 771.

In some embodiments, the holster also includes at least one hook protruding from the backing plate. In those embodiments, according to another, optional operation 640, the ribbon is engaged in the hook. In the example of FIG. 7, ribbon 777 will be engaged by hook 142. In some embodiments, the entire ribbon 777 will be placed behind hook 142. Another embodiment is now described.

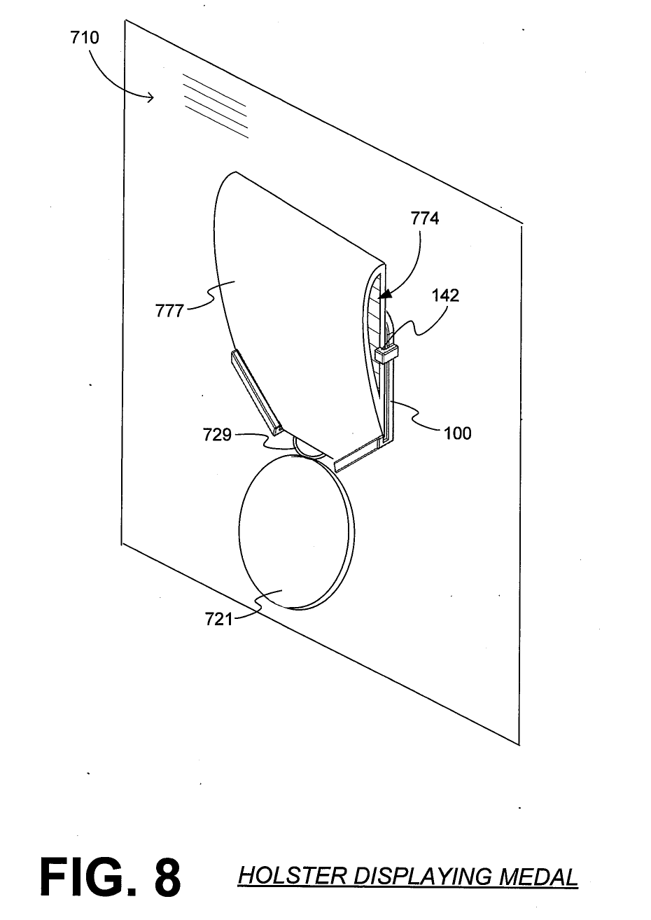

FIG. 8 is a perspective view of the holster of FIG. 1, after a specific embodiment of FIG. 7 has been implemented. Ribbon 777 includes fold 774, and engaging includes having hook 142 be received in fold 774. This way, less of hook 774 is visible, allowing more of ribbon 777 to be visible.

A few items are noteworthy. First, holster 100 has been manufactured with dimensions substantially anticipating the dimensions of ribbon 777, so that the widths match and both hooks can be engaged, the incline of the shelves matches the incline of the ribbon's underside, and so on. Equivalently, when operation 610 is performed, the holster is preferably procured with dimensions substantially anticipating the dimensions of the ribbon.

Second, ribbon 777 is taller than the backing plate. In fact, the backing plate can be ideally mostly covered by ribbon 777. In some embodiments, the backing plate need not be taller than it has to be for raising hook 142 to the appropriate height.

Third, ribbon 777 is shown with its back side rather straight. With time, it the ribbon may droop. That is why it is preferred to prepare holster 100 with dimensions so that hook 142 will be near the top of fold 774.

In some embodiments, at least a certain one of the shelves includes a fence. In those embodiments, supporting operation 630 includes placing a portion of the ribbon between the backing plate and the fence. An example is now described.

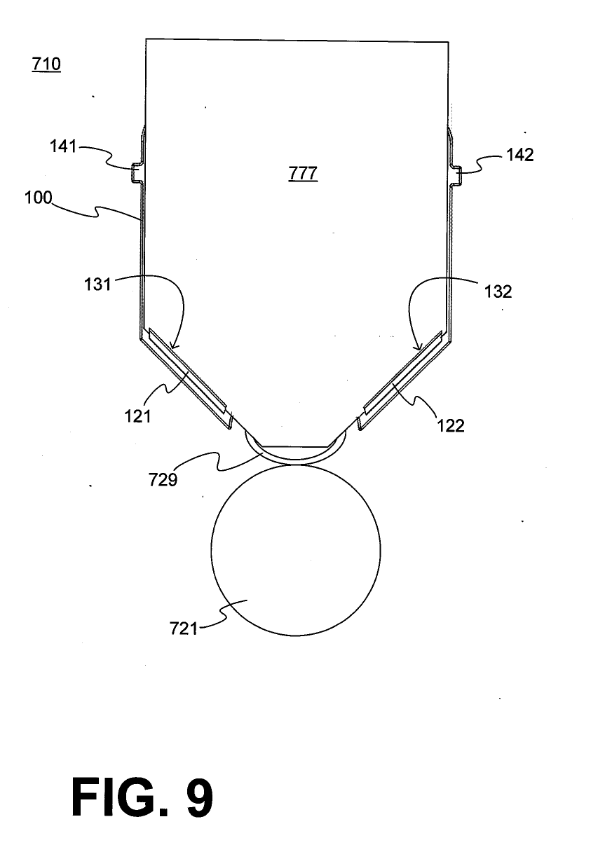

FIG. 9 is a front view of the perspective view of FIG. 8. Holster 100 is supporting medal 721 on vertical surface 710. Holster 100 includes shelves 121, 122. Shelves 121, 122 include fences 131, 132 respectively. Supporting operation 630 included placing a portion of ribbon 777, such as underside 771 shown in FIG. 7, between the backing plate and fences 131, 132. It will be appreciated that the view of ribbon 777 is not obstructed much.

In the methods described above, each operation can be performed as an affirmative step of doing, or causing to happen, what is written that can take place. Such doing or causing to happen can be by the whole system or device, or just one or more components of it. In addition, the order of operations is not constrained to what is shown, and different orders may be possible according to different embodiments. Moreover, in certain embodiments, new operations may be added, or individual operations may be modified or deleted. The added operations can be, for example, from what is mentioned while primarily describing a different system, device or method.

Embodiments also include creating devices using 3D printing. 3D printing is a technology that is also known as additive manufacturing for creating devices, such as the holsters described above. A 3D printer system has a nozzle that deposits molten material that dries out in the shape of a desired device. The device is as desired because depositing is according to a pattern. The pattern is according to one or more data files. A 3D printer is associated by a computer that stores such one or more data files according to embodiments. The computer may be part of the 3D printer system, or separate. The nozzle is controlled according to the one or more data files. As such, the one or more data files including instructions which, when executed by a computer associated with a 3D printer, cause the 3D printer to build a device that is according to embodiments.

Embodiments further include performing operations to enable such 3D printing. These operations include creating the one or more data files, transmitting them, and/or enabling them their transmission by uploading them in a computer from where they can be downloaded.

Embodiments also include non-transitory computer-readable storage media storing such data files. These media can be computers and memories at the point of creation, intermediate storing of the data file, or actual use for 3D printing.

This description includes one or more examples, but that does not limit how the invention may be practiced. Indeed, examples or embodiments of the invention may be practiced according to what is described, or yet differently, and also in conjunction with other present or future technologies.

Reference to any prior art in this specification is not, and should not be taken as, an acknowledgement or any form of suggestion that this prior art forms parts of the common general knowledge in any country.

A person skilled in the art will be able to practice the present invention in view of this description, which is to be taken as a whole. In addition, the word holster means also holder. Details have been included to provide a thorough understanding. In other instances, well-known aspects have not been described, in order to not obscure unnecessarily the present invention.

Other embodiments include combinations and sub-combinations of features described herein, including for example, embodiments that are equivalent to: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

What is claimed is:

1. A holster configured to display on a vertical surface a medal suspended from a ribbon, comprising:
a backing plate having a front face and a rear face, the rear face configured to be attached to the vertical surface; and
two shelves attached to the front face and configured to support the ribbon, the shelves leaving a vacant space between them for the medal to be suspended through the vacant space when the ribbon is supported on the shelves.

2. The holster of claim 1, in which
the shelves are substantially inclined with respect to each other.

3. The holster of claim 1, in which
the shelves are substantially perpendicular to each other.

4. The holster of claim 1, in which
the shelves are oblong and continuous.

5. The holster of claim 1, in which
the backing plate has a bottom side, and
the backing plate has cutout at the bottom side proximately to the vacant space.

6. The holster of claim 1, in which
at least a certain one of the shelves includes a fence configured to prevent the ribbon from sliding off the certain shelf.

7. The holster of claim 6, in which
the fence is coextensive with the shelf.

8. The holster of claim 1, further comprising:
at least one hook protruding from the backing plate and configured to engage the ribbon.

9. The holster of claim 8, in which
the backing plate has two side edges, and
the hook protrudes from one of the side edges.

10. The holster of claim 8, in which
the ribbon includes a fold, and
the hook is configured to be received in the fold.

11. A method for displaying on a vertical surface a medal suspended from a ribbon, comprising:
procuring a holster having a backing plate, two shelves that leave a vacant space between them;
attaching the backing plate to the vertical surface; and
supporting the ribbon on the shelves such that the medal becomes suspended through the vacant space.

12. The method of claim 11, in which
at least a certain one of the shelves includes a fence, and
supporting includes placing a portion of the ribbon between the backing plate and the fence.

13. The method of claim 11, in which
the holster also includes at least one hook protruding from the backing plate, and further comprising: engaging the ribbon in the hook.

14. The method of claim 13, in which
the ribbon includes a fold, and
engaging includes having the hook be received in the fold.

15. A non-transitory computer-readable storage medium storing one or more data files, the one or more data files including instructions which, when executed by a computer associated with a 3D printer, cause the 3D printer to build a device comprising:
a backing plate having a front face and a rear face, the rear face configured to be attached to the vertical surface; and
two shelves attached to the front face and configured to support the ribbon, the shelves leaving a vacant space between them for the medal to be suspended through the vacant space when the ribbon is supported on the shelves.

16. The non-transitory computer-readable storage medium of claim 15, in which the shelves are substantially inclined with respect to each other.

17. The non-transitory computer-readable storage medium of claim 15, in which the shelves are oblong and continuous.

18. The non-transitory computer-readable storage medium of claim 15, in which
the backing plate has a bottom side, and
the backing plate has cutout at the bottom side proximately to the vacant space.

19. The non-transitory computer-readable storage medium of claim 15, in which
at least a certain one of the shelves includes a fence configured to prevent the ribbon from sliding off the certain shelf.

20. The non-transitory computer-readable storage medium of claim 15, in which the device further comprises:
at least one hook protruding from the backing plate and configured to engage the ribbon.
